(19) United States
(12) Patent Application Publication
(10) Pub. No.: US 2013/0258652 A1
(43) Pub. Date: Oct. 3, 2013

(54) LIGHT-GUIDING ELEMENT, ILLUMINATION MODULE AND LAMINATE LAMP APPARATUS

(71) Applicant: LEXTAR ELECTRONICS CORPORATION, Hsinchu (TW)

(72) Inventors: Shang-Jung HSIEH, Hsinchu County (TW); Chun-Hung LIU, Kaohsiung City (TW); Chi-Cheng CHENG, Hsinchu County (TW); Sheng-Ping CHEN, Kaohsiung City (TW)

(73) Assignee: Lextar Electronics Corporation, Hsinchu (TW)

(21) Appl. No.: 13/851,969

(22) Filed: Mar. 28, 2013

(30) Foreign Application Priority Data
Apr. 3, 2012 (TW) 101111846

(51) Int. Cl. F21V 7/00; F21V 13/10

(52) U.S. Cl. CPC F21V 7/0033; F21V 13/10
USPC 362/225; 362/346; 362/217.05

(57) ABSTRACT

A light-guiding element, an illumination module and a laminate lamp apparatus are provided. The light-guiding element comprises an upper reflection member extended along a longitudinal axis direction, and a lower reflection member extended along the longitudinal axis direction thereof and coupled to the upper reflection member. The lower reflection member comprises a first reflective portion with at least a first inclined flat plate, and the upper reflection member comprises a second reflective portion facing towards the first reflective portion. A light placement portion and a light outputting trough are formed between the first reflective portion and the second reflective portion. The light outputting trough is gradually expanded largely according to a direction of being away from the light placement portion.

### RELATED APPLICATIONS

This application claims priority to Taiwan Application Serial Number 101111846, filed Apr. 3, 2012, which is herein incorporated by reference.

### BACKGROUND

1. Technical Field

The present disclosure relates to a light-guiding element, an illumination module and a laminate lamp apparatus.

2. Description of Related Art

Traditional light adjusting devices for adjusting the light emitting angle of a light source are divided into three classes: the first class adjusts the light emitting angle of the light source by changing a lens curve surface, the second class achieves the effect of concentrating light by utilizing a common diffraction element, and the third class adjusts the light emitting angle of the light source through secondary optics by utilizing a reflecting cover.

However, concerning the structure of the above traditional light adjusting devices, a manner for producing the above traditional light adjusting devices is complicated, so as hardly to provide an easy solution in manufacture and cost.

It can be seen that the existing light adjusting devices still have inconvenience and disadvantages, and need further improvements. Therefore, many in the industry are endeavoring to find ways in which to effectively solve the above inconvenience and disadvantages.

### SUMMARY

According to an aspect of the present disclosure, the light-guiding element includes an upper reflection member and a lower reflection member. The lower reflection member extends along a longitudinal axis direction and includes a first reflective portion which includes at least one first inclined flat plate. The upper reflection member extends along the longitudinal axis direction, is connected to the lower reflection member and includes a second reflective portion. The first reflective portion faces towards the second reflective portion. A light placement portion and a light outputting trough are formed between the first reflective portion and the second reflective portion. The light outputting trough is gradually expanded largely according to a direction of being away from the light placement portion.

According to another aspect of the present disclosure, the illumination module includes the above light-guiding element and a linear light source. The linear light source extends along a longitudinal axis direction, is arranged in the light placement portion and diverges light towards the light outputting trough.

According to yet another aspect of the present disclosure, the laminate lamp apparatus includes two above illumination modules and a light diffusion plate. The light diffusion plate is positioned on one face of the upper reflection member, opposite to the second reflective portion.

### BRIEF DESCRIPTION OF THE DRAWINGS

In order to make the following as well as other aspects, features, advantages, and embodiments of the present disclosure more apparent, the accompanying drawings are described as follows:

FIG. 1 illustrates a schematic perspective view of a change of the illumination module in an embodiment of the present disclosure;

FIG. 2 illustrates a cross-sectional view along a line 2-2 of FIG. 1;

FIG. 3 illustrates a transverse cross-sectional view of another change of the illumination module in the embodiment of the present disclosure;

FIG. 4 illustrates a transverse cross-sectional view of yet another change of the illumination module in the embodiment of the present disclosure;

FIG. 5a illustrates a transverse cross-sectional view of a change of the laminate lamp apparatus in the embodiment of the present disclosure;

FIG. 5b illustrates a transverse cross-sectional view of another change of the laminate lamp apparatus in the embodiment of the present disclosure;

FIG. 6a illustrates a transverse cross-sectional view of a change of the illumination module in another embodiment of the present disclosure;

FIG. 6b illustrates a transverse cross-sectional view of a change of the laminate lamp apparatus in the embodiment of the present disclosure;

FIG. 7a illustrates a transverse cross-sectional view of another change of the illumination module in the embodiment of the present disclosure;

FIG. 7b illustrates a transverse cross-sectional view of another change of the laminate lamp apparatus in the embodiment of the present disclosure;

FIG. 8 illustrates a partial transverse cross-sectional view of the illumination module of the present disclosure in yet another embodiment;

FIG. 9a illustrates a schematic perspective view of one change of the illumination module in still yet another embodiment of the present disclosure;

FIG. 9b illustrates a transverse cross-sectional view of FIG. 9a;

FIG. 10a illustrates a transverse cross-sectional view of a change of the laminate lamp apparatus in the embodiment of the present disclosure;

FIG. 10b illustrates a transverse cross-sectional view of another change of the laminate lamp apparatus in the embodiment of the present disclosure;

FIG. 11a illustrates a transverse cross-sectional view of another change of the illumination module in still yet another embodiment of the present disclosure;

FIG. 11b illustrates a transverse cross-sectional view of yet another change of the laminate lamp apparatus in still yet another embodiment of the present disclosure;

FIG. 12a illustrates a transverse cross-sectional view of yet another change of the illumination module in still yet another embodiment of the present disclosure; and

FIG. 12b illustrates a transverse cross-sectional view of still yet another change of the laminate lamp apparatus in still yet another embodiment of the present disclosure.

### DETAILED DESCRIPTION

Reference will now be made in detail to the embodiments of the present disclosure, examples of which are illustrated in the accompanying drawings. Wherever possible, the same reference numbers are used in the drawings and the description to refer to the same or like parts. As used herein, the singular forms “a,” “an” and “the” include plural referents unless the context clearly dictates otherwise. It will be apparent to those ordinarily skilled in the art that various modifications and variations can be made without departing from the scope and the spirit of the present disclosure.

The present disclosure provides a light-guiding element, illumination module and laminate lamp apparatus, so as to effectively adjust the light emitting angle and concentrate a light emitting range.

The present disclosure provides the light-guiding element, illumination module and laminate lamp apparatus, so as not only to solve the above inconvenience and disadvantages, but also to provide a solution which is easy in production and low in cost.

The present disclosure provides the light-guiding element, illumination module and laminate lamp apparatus, so as to effectively guide the light emitting direction and enable a thinner overall structure.

Compared with the prior art, the technical solution according to embodiments of the present disclosure has remarkable advantages and beneficial effects. With the technical solution, significant technological progress and practicability are achieved by the embodiments of the present disclosure which can be widely used in the industry. The present disclosure has for example the following advantages:

1. an expected light emitting angle is obtained by adjusting through multiple adjacent inclined flat plates with different angles; and

2. since the structure of the light-guiding element is simple, compared with the production of the above traditional light adjusting devices, the production of the light-guiding element is easy and the cost is low.

The above illustration and the following detailed description will be described in detail through embodiments as follows, and the present disclosure is further explained.

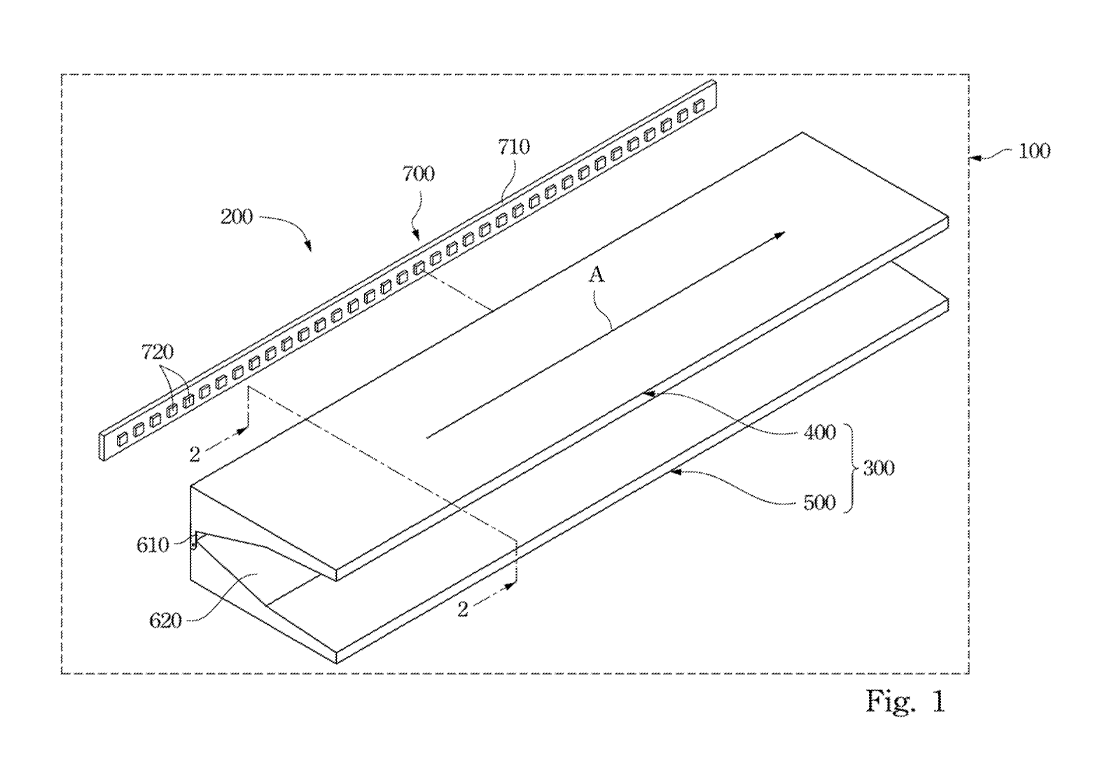

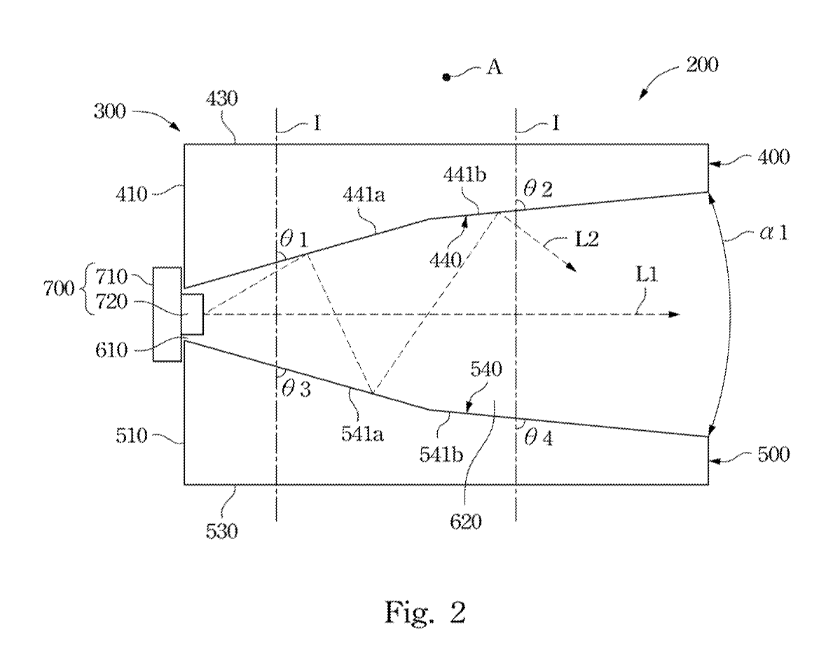

Referring to FIGS. 1 and 2, FIG. 1 illustrates a schematic perspective view of a change of the illumination module in an embodiment of the present disclosure; and FIG. 2 illustrates a cross-sectional view along a line 2-2 of FIG. 1.

The present disclosure provides an illumination module 200, and the illumination module 200 includes a light-guiding element 300 and a linear light source 700.

The light-guiding element 300, such as a light concentrating cover, includes an upper reflection member 400 and a lower reflection member 500. The upper reflection member 400 and the lower reflection member 500 are strip-shaped and both extend along a longitudinal axis direction A. The upper reflection member 400 and the lower reflection member 500 can be assembled together or be disassembled from each other. One side of the lower reflection member 500 and one side of the upper reflection member 400, which are opposite to each other, respectively include a first reflective portion 540 and a second reflective portion 440. The first reflective portion 540 faces towards the second reflective portion 440. Therefore, when the upper reflection member 400 and the lower reflection member 500 are connected with each other by being assembled together, the second reflective portion 440 keeps a distance away from the first reflective portion 540, and a light placement portion 610 and a light outputting trough 620 which are connected with each other are formed between the first reflective portion 540 and the second reflective portion 440. Both the light placement portion 610 and the light outputting trough 620 extend along the longitudinal axis direction A, and the light outputting trough 620 expands largely outwards. That is, the light outputting trough 620 is gradually expanded largely according to a direction of being away from the light placement portion 610. The first reflective portion 540 includes one or more first inclined flat plates (such as 541a and 541b in FIG. 2). The second reflective portion 440 includes one or more second inclined flat plates such as 441a and 441b in FIG. 2).

In the embodiment of the present disclosure, the second reflective portion 440 is arranged to be symmetric to the first reflective portion 540 (as shown in FIG. 2), and the exterior structures of the second reflective portion 440 and the first reflective portion 540 are symmetric to each other (or referred to as reflection of each other). However, the present disclosure is not limited to this, and in other embodiments, the second reflective portion and the first reflective portion may be arranged to be not symmetric to each other, and the exterior structures of the second reflective portion and the first reflective portion are not symmetric to each other.

The linear light source 700 is arranged in the light placement portion 610, extends along the above longitudinal axis direction A, and emits light from the light placement portion 610 to the light outputting trough 620. The above linear light source 700 of the present disclosure is not limited in form, and may be a light emitting diode (LED), organic light-emitting diodes (OLED), tubes or bulbs. In this embodiment, the linear light source 700 is a light bar of the LED and includes at least one circuit hoard 710 and multiple light emitting diodes (LEDs) 720. These LEDs 720 are linearly arranged on the circuit board 710 to form the light bar. These LEDs 720 are all arranged in the light placement portion 610, facing towards the light outputting trough 620 and all emit light towards the light outputting trough 620. The circuit board 710 is not limited in form, and may be a rigid printed circuit board (RPCB), a metal core printed circuit board (MCPCB) or a flexible printed circuit board (FPC).

In this way, when the linear light source 700 emits light towards the light outputting trough 620, part of light L1 is directly emitted towards the light outputting trough 620, and the rest light L2 is gradually sent to the light outputting trough 620 after being repeatedly reflected by the second inclined flat plates 441a and 441b and the first inclined flat plates 541a and 541b, so that all directive lights of the liner light source 700 are concentrated to the light outputting trough 620.

Specifically, the lower reflection member 500 further includes a first side face 510 and a first plane 530. The first plane 530 is arranged opposite to the first reflective portion 540. The first side face 510 is adjacent to one side of the linear light source 700 and is adjacent to the first plane 530 and the first inclined flat plate 541a of the first reflective portion 540 respectively. The upper reflection member 400 further includes a second side face 410 and a second plane 430. The second plane 430 is arranged opposite to the second reflective portion 440. The second side face 410 is adjacent to the other side of the linear light source 700 and is adjacent to the second plane 430 and a second inclined flat plate 441a of the second reflective portion 440 respectively, so that the linear light source 700 is between the second side face 410 and the first side face 510. In addition, the second plane 430 is arranged opposite and parallel to the first plane 530.

In a change of the embodiment, as shown in FIG. 2, the second reflective portion 440 is formed by multiple sequentially-adjacent second inclined flat plates (such as 441a and 441b) with different inclined angles, and these second inclined flat plates (such as 441a and 441b) gradually approach to be flat according to respective distance from the light placement portion 610. The inclination of the second inclined flat plate (such as 441b) which is farthest from the light placement portion 610, i.e., the flattest second inclined flat plate (such as 441b), just approaches to that of the second plane 430 or the first plane 530, but the second inclined flat plate is not parallel to the second plane 430 or the first plane 530. The first reflective portion 540 is also formed by multiple sequentially-adjacent first inclined flat plates (such as 541a and 541b) with different inclination angles.

Since the exterior structures of the second reflective portion 440 and the first reflective portion 540 are symmetric to each other, the exterior structures of these first inclined flat plates 541a and 541b and these second inclined flat plates 441a and 441b are symmetric to each other. These first inclined flat plates 541a and 541b gradually approach to be flat according to respective distance from the light placement portion 610. The inclination of the first inclined flat plate 541b which is farthest from the light placement portion 610, i.e., the flattest first inclined flat plate 541b, just approaches to that of the second plane 430 or the first plane 530, but the first inclined flat plate 541b is not parallel to the second plane 430 or the first plane 530.

Therefore, an included angle formed by a virtual datum plane I vertical to the second plane 430 and the first plane 530 and any second inclined flat plate 441a or 441b (or the first inclined flat plate 541a or 541b) is an acute angle and is not larger than or equal to 90° (degrees). That is, all included angles between the second inclined flat plate 441a and 441b (or the first inclined flat plates 541a and 541b) and the virtual datum planes I are gradually increased, but are smaller than 90° (degrees).

In a change of the embodiment, referring to FIG. 2, the second reflective portion 440 includes two second inclined flat plates 441a and 441b which are adjacent to each other, and the inclination of the two second inclined flat plates 441a and 441b are different. The first reflective portion 540 includes two first inclined flat plates 541a and 541b which are adjacent to each other, and the inclination of the two first inclined flat plates 541a and 541b are different.

For example, when included angles θ1 and θ2 formed between the two second inclined flat plates 441a and 441b and the above virtual datum planes I along the direction of being away from the light placement portion 610 is 50° (degrees) and 80° (degrees) sequentially, and included angles θ3 and θ4 formed between the first inclined flat plates 541a and 541b and the above virtual datum planes I along the direction of being away from the light placement portion 610 is 50° (degrees) and 80° (degrees) sequentially. The light-guiding element 300 enables the light emitting angle α1 of the linear light source 700 to be reduced to 30° (degrees) from 120° (degrees), so as to achieve the effect of guiding and concentrating the light.

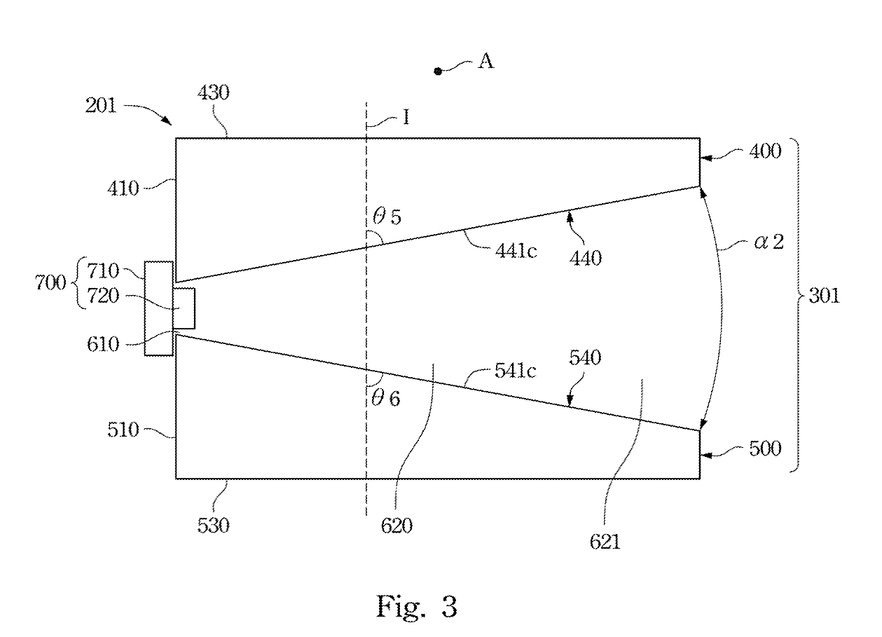

Referring to FIG. 3, FIG. 3 illustrates a transverse cross-sectional view of another change of the illumination module 201 in the embodiment of the present disclosure.

In another change of the embodiment, the first reflective portion 540 only has a single first inclined flat plate 541c, and the second reflective portion 440 only has a single second inclined flat plate 441c. The exterior structures of the second inclined flat plate 441c and the first inclined flat plate 541c are symmetric to each other.

For example, when included angles θ5 formed between the second inclined flat plate 441c and the above virtual datum planes I are all 75° (degrees), and included angles θ6 formed between the first inclined flat plate 541c and the above virtual datum planes I are all 75° (degrees), the light-guiding element 301 enables the light emitting angle α2 of the linear light source 700 to be reduced to 24 degrees from 120° (degrees), so as to achieve the effect of guiding and concentrating light.

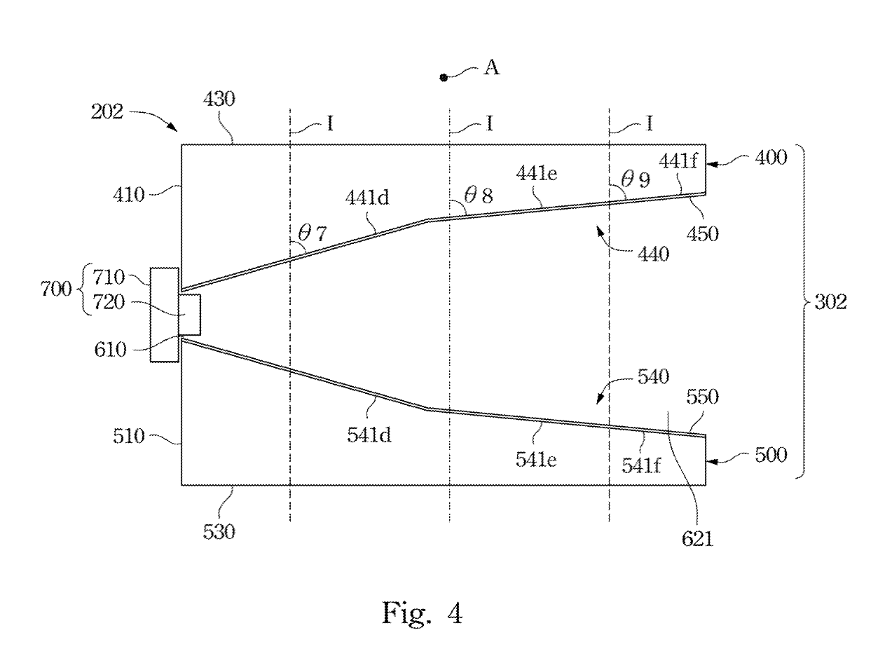

Referring to FIG. 4, FIG. 4 illustrates a transverse cross-sectional view of yet another change of the illumination module 202 in the embodiment of the present disclosure. In yet another change of the embodiment, the second reflective portion 440 includes three second inclined flat plates 441d-441f which are adjacent in sequence, and the inclination of these second inclined flat plates 441d-441f approaches to be flat according to respective distance from the light placement portion 610. The first reflective portion 540 includes three first inclined flat plates 541d-541f which are adjacent in sequence, and the inclination of these first inclined flat plates 541d-541f approaches to be flat according to respective distance from the light placement portion 610.

For example, when included angles θ7, θ8 and θ9 are formed between the three second inclined flat plates 441d-441f and the above virtual datum planes I along the direction of being away from the light placement portion 610, the relation among θ7, θ8 and θ9 is θ7<θ8<θ9. Similarly, the relation among the included angles formed between the three second inclined flat plates 441d-441f and the above virtual datum planes I is identical to that of the included angles θ7, θ8 and θ9.

In addition, the upper reflection member 400 and the lower reflection member 500 of the light-guiding element 302 of the present disclosure are both made of metal materials (such as aluminum) or nonmetal materials (such as plastic). When the upper reflection member 400 and the lower reflection member 500 of the light-guiding element 302 of the present disclosure are made of metal materials (such as aluminum), the metal materials enable the second reflective portion 440 and the first reflective portion 540 to have the capability of improving light reflection.

Since the structure of the light-guiding element of the present disclosure is simple, compared with the production of the above traditional light adjusting devices, in the present disclosure the light-guiding element which is easy to produce and low in cost is provided by for example utilizing an aluminum extrusion process.

However, no matter whether the upper reflection member 400 and the lower reflection member 500 of the light-guiding element 302 are made of metal materials or nonmetal materials, in yet another change of the embodiment, referring to FIG. 4, a second light reflecting layer 450 is adhered onto these second inclined flat plates 441d-441f and a first light reflecting layer 550 is adhered to these first inclined flat plates 541d-541f. The second light reflecting layer 450 and the first light reflecting layer 550 have the capability of enhancing light reflection.

However, the second light reflecting layer 450 and the first light reflecting layer 550 of the present disclosure are not limited to FIG. 4. The second inclined flat plates 441a-441c of the second reflective portion 440 and the first inclined flat plates 541a-541c of the first reflective portion 540 in other embodiments of the present disclosure all are optionally adhered with the second light reflecting layer 450 and the first light reflecting layer 550.

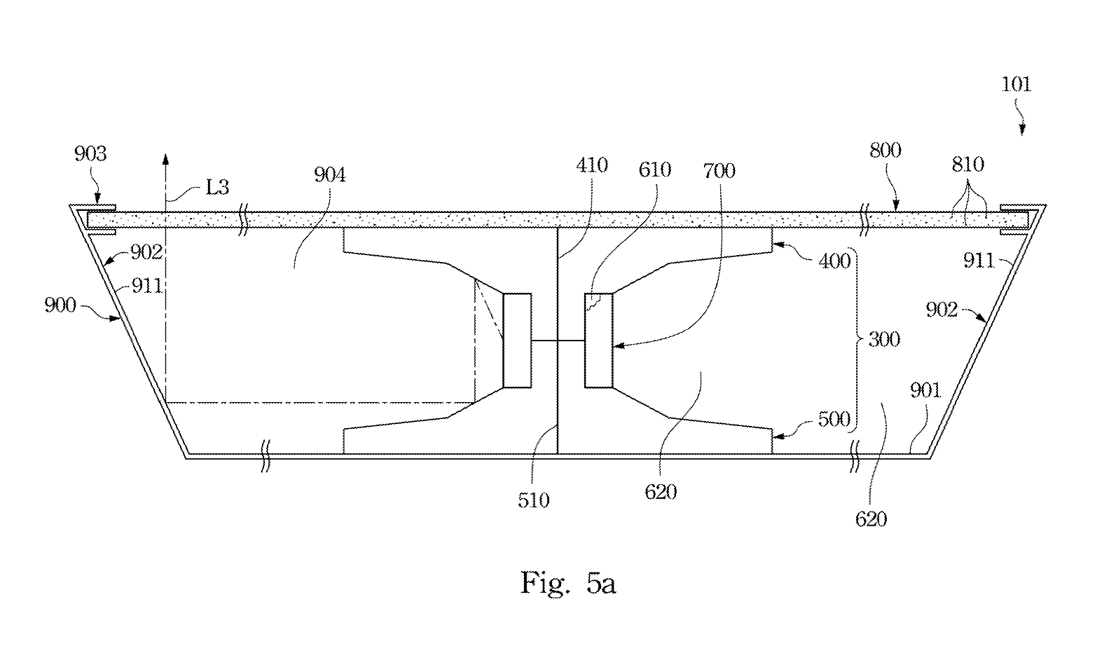

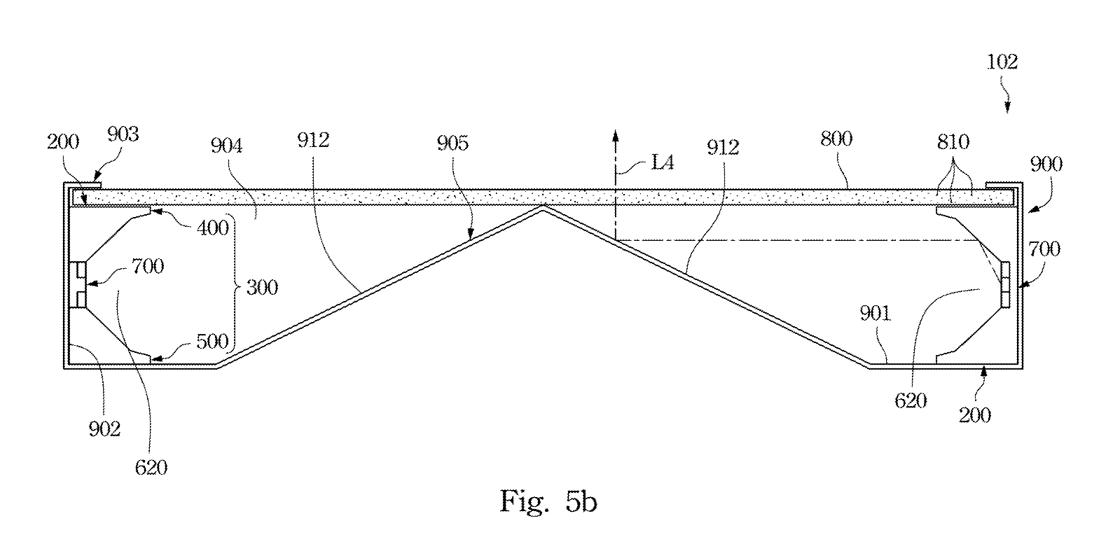

Referring to FIG. 5a, FIG. 5a illustrates a transverse cross-sectional view of a change of the laminate lamp apparatus 101 in the embodiment of the present disclosure.

The present disclosure provides a laminate lamp apparatus 101. The laminate lamp apparatus 101 includes two above illumination modules 200, a light diffusion plate 800 and a fixing frame 900. The fixing frame 900 includes a bottom face 901, multiple inner walls 902 and at least one clamping portion 903. These inner walls 902 and the bottom face 901 define an accommodation groove 904 which is used for accommodating these illumination modules 200. The clamping portion 903 is positioned on one side of the fixing frame 900, which is opposite to the bottom face 901, so as to enable the light diffusion plate 800 to be just embedded and fixed on the upper reflection member 400 via a gap. The light diffusion plate 800 diffuses light passing through the light diffusion plate 800, and more particularly, the light diffusion plate 800 contains diffusion particles 810 (such as metal powder, ink or fluorescent powder). The light diffusion plate 800 causes the diffuse reflection phenomenon by utilizing the diffusion particles 810, so that the above light is diffused with different angles after being reflected, and thus the light is outputted outwards uniformly.

In FIG. 5a, specifically, the two light-guiding elements 300 are arranged in reverse directions on the bottom face 901. That is, one face (i.e., the first side face 510) of one light-guiding element 300 and one face (i.e., the second side face 410) of the other light-guiding element 300, which are away from the light outputting troughs 620, face towards each other (even are bonded to each other in other embodiments). The two linear light sources 700 are both between the two light outputting troughs 620 and respectively face towards one of the inner walls 902 at a reverse direction, so that each linear light source 700 emits light L3 to the inner wall 902 facing towards the linear light source 700 along an opposite direction via respective light outputting trough 620. In addition, each inner wall 902 facing towards the linear light source 700 has a first light reflecting inclined plane 911. The first light reflecting inclined plane 911 is used for reflecting light from each linear light source 700 to the light diffusion plate 800.

In this way, when each light-guiding element 300 guides the light L3 from the linear light source 700 to the inner wall 902 facing towards the linear light source 700 in a concentrated way, each first light reflecting inclined plane 911 reflects light L3 from each linear light source 700 to the light diffusion plate 800, and with the light diffusion effect of the light diffusion plate 800, the laminate lamp apparatus 101 provides an area light source with uniform light on one side of the light diffusion plate 800.

Referring to FIG. 5b, FIG. 5b illustrates a transverse cross-sectional view of another change of the laminate lamp apparatus 102 in the embodiment of the present disclosure.

In FIG. 5b, specifically, the two light-guiding elements 300 are arranged on the bottom face 901, opposite to each other and are respectively adhered to one of the inner walls 902, so that the two light-guiding elements 300 keep a distance away from each other. That is, the two light-guiding elements 300 are opposite to each other via the light outputting troughs 620. The two light outputting troughs 620 are both between the two linear light sources 700, so that the two linear light sources 700 output light along directions opposite to each other.

In addition, the fixing frame 900 further includes a protruding portion 905. The protruding portion 905 is positioned on the bottom face 901, between the two linear light sources 700, and protrudes towards the direction of the light diffusion plate 800. The protruding portion 905 at least includes two adjacent second light reflecting inclined planes 912, and each second light reflecting inclined plane 912 faces towards one of the above linear light sources 700.

In the present disclosure, it is not limited whether the protruding portion 905 is contacted or not contacted with the light diffusion plate 800. The protruding portion 905 helps to carry the light diffusion plate 800 when being contacted with the light diffusion plate 800.

In this way, when each light-guiding element 300 guides the light L4 from the linear light sources 700 to the second light reflecting inclined plane 912 facing towards the linear light source 700 in a concentrated way, the second light reflecting inclined plane 912 reflects the light L4 from each linear light source 700 to the light diffusion plate 800, and with the light diffusion effect of the light diffusion plate 800, the laminate lamp apparatus 102 provides an area light source with uniform light on one side of the light diffusion plate 800.

However, it should be understood that in the present disclosure, the protruding portion 905 is not limited to be formed below these second light reflecting inclined planes 912 and can be solid or hollow.

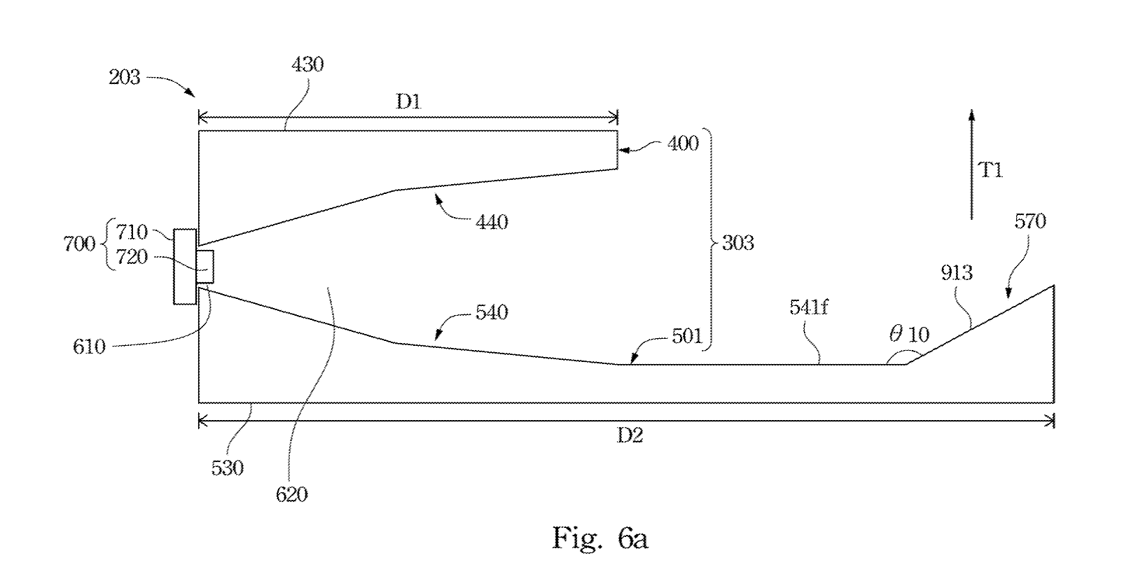

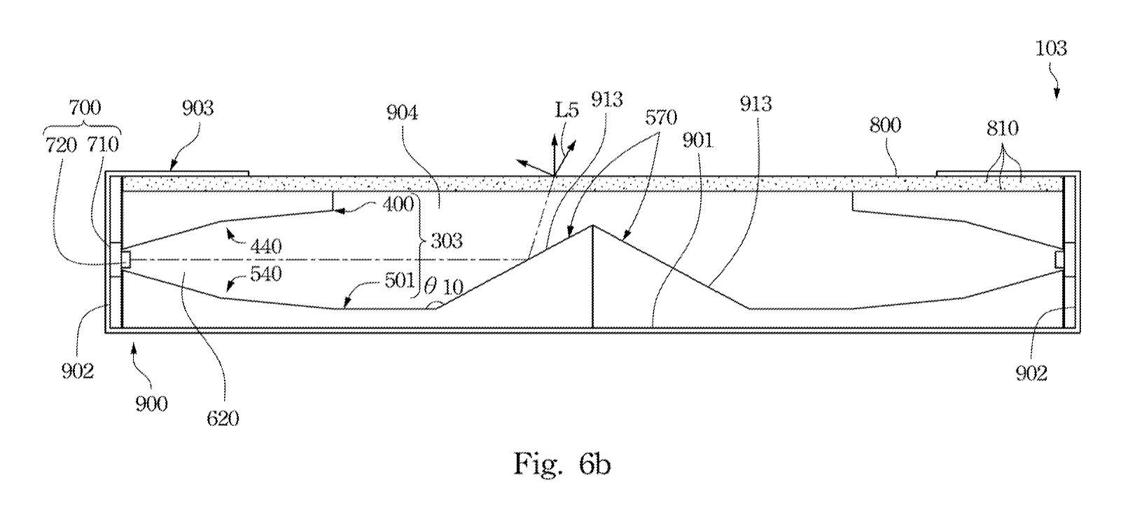

Referring to FIG. 6a, FIG. 6a illustrates a transverse cross-sectional view of a change of the illumination module 203 in another embodiment of the present disclosure.

In a change of another embodiment, the exterior structures of the second reflective portion 440 and the first reflective portion 540 of the light-guiding element 303 are not symmetric to each other.

For example, the lower reflection member 501 is protruded more than the upper reflection member 400, so that the width D2 of the lower reflection member 501 (i.e., the first plane 530) is greater than the width D1 of the upper reflection member 400 (i.e., the second plane 430).

In addition, the first reflective portion 540 is protruded more than the second reflective portion 440 and the lower reflection member 501 includes a protruding portion 570. The protruding portion 570 is positioned on one side of the first reflective portion 540 (such as the first inclined flat plate 541f), which is farthest from the light placement portion 610, and the protruding portion 570 protrudes towards a direction of the lower reflection member 501, which is opposite to (or away from) the first plane 530, so as to reflect light to a direction T1 of the upper reflection member 400 reverse to the lower reflection member 501. The protruding portion 570 for example includes a third light reflecting inclined plane 913. The third light reflecting inclined plane 913 is connected to a first inclined flat plate 541f at the outermost side and inclines towards a direction of being away from the light placement portion 610 and the first plane 530, so that the third light reflecting inclined plane 913 faces towards the linear light source 700.

In this way, when the linear light source 700 emits light, the light-guiding element 303 guides light to the third light reflecting inclined plane 913 in a concentrated way, and then the third light reflecting inclined plane 913 guides all the light to move towards a direction (such as direction T1) of the upper reflection member 400 of the light-guiding element 303.

For example, an included angle 810 formed between the third light reflecting inclined plane 913 and the adjacent first inclined flat plate 541f is between 150° (degrees) and 180° (degrees).

In addition, one side of the protruding portion 570, which is away from the linear light source 700, is vertical to the first plane 530, and the protruding portion 570 is bonded with other components so as to stabilize the placement of the illumination module 200.

Referring to FIG. 6b, FIG. 6b illustrates a transverse cross-sectional view of a change of the laminate lamp apparatus 100 in the embodiment of the present disclosure.

FIG. 6b shows the laminate lamp apparatus 103 formed by two illumination modules 203 shown in FIG. 6a.

Specifically, the two light-guiding elements 303 are connected with each other via the protruding portions 570. One side of one protruding portion 570 and one side of the other protruding portion 570, which are away from the linear light sources 700, are bonded with each other. The upper reflection members 400 of the two light-guiding elements 303 keep a distance away from each other and cannot be connected physically. Furthermore, the two protruding portions 570 and the light outputting troughs 620 are all between the two linear light sources 700, and each linear light source 700 outputs light L5 to the corresponding third light reflecting inclined plane 913 via its light outputting trough 620.

In this way, when each light-guiding element 303 guides the light L5 from the linear light sources 700 to the third light reflecting inclined planes 913 in a concentrated way, each third light reflecting inclined plane 913 reflects the light L5 from each linear light source 700 to the light diffusion plate 800, and with the light diffusion effect of the light diffusion plate 800, the laminate lamp apparatus 103 provides an area light source with uniform light on one side of the light diffusion plate 800.

However, this embodiment of the present disclosure is not limited by the above, and the protruding portions 570 of the two light-guiding elements 303 also can keep a distance from each other.

In addition, in other changes of the above embodiment, it is seen from FIG. 6b that, the above two protruding portions are also regarded as a singly formed triangular protruding portion, and that is the two lower reflection members (such as the lower reflection members 501 of FIG. 6b) are integrated into a single component. This triangular protruding portion has two third light reflecting inclined planes (such as the third light reflecting inclined plane 913 of FIG. 6b), and these third light reflecting inclined planes are adjacent to each other to jointly form an included angle protruding towards the direction of the light diffusion plate (such as the light diffusion plate 800 of FIG. 6b).

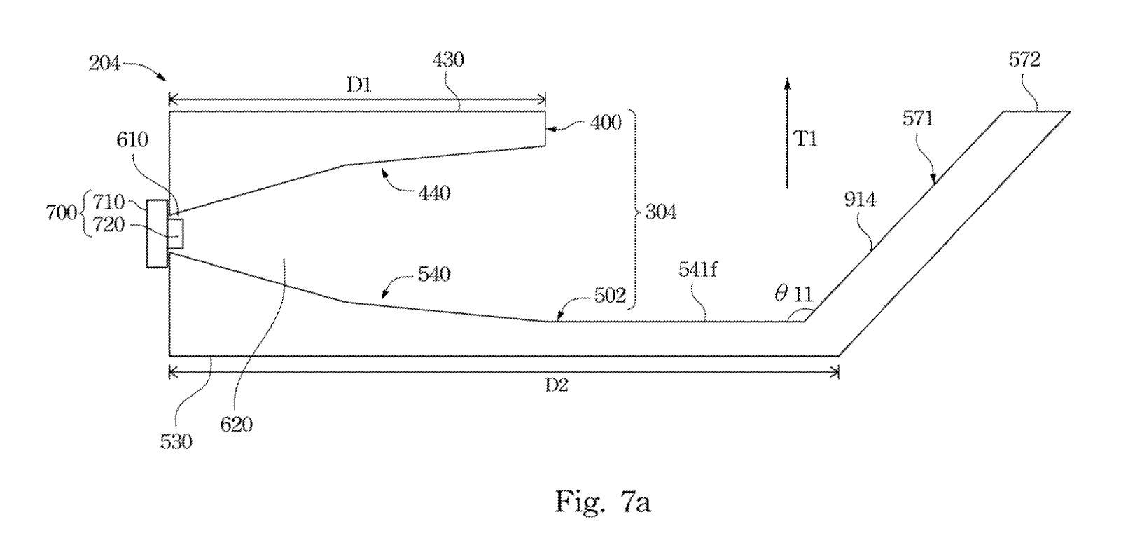

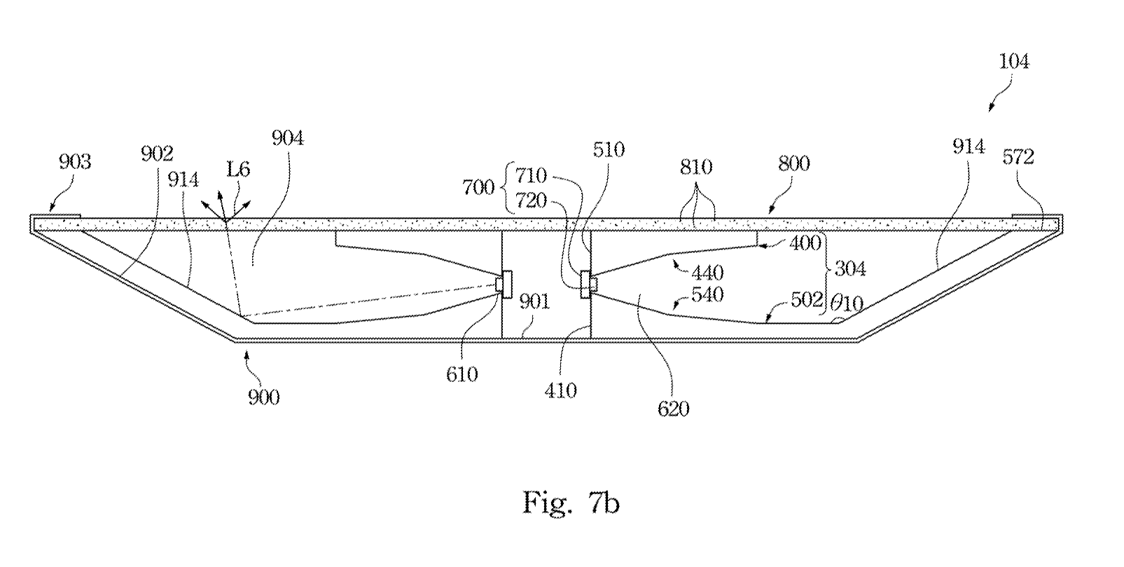

Referring to FIG. 7a, FIG. 7a illustrates a transverse cross-sectional view of another change of the illumination module 204 in the embodiment of the present disclosure.

In a change of another embodiment, the exterior structures of the second reflective portion 440 and the first reflective portion 540 of the light-guiding element 304 are not symmetric to each other.

For example, the lower reflection member 502 is protruded more than the upper reflection member 400, so that the width D2 of the lower reflection member 502 (i.e., the first plane 530) is greater than the width 21 of the upper reflection member 400 (i.e., the second plane 430).

In addition, the first reflective portion 540 is protruded more than the second reflective portion 440, and the lower reflection member 502 includes a protruding portion 571. The protruding portion 571 is platy-shaped, and is arranged on one side edge of the first reflective portion 540 (such as the first inclined flat plate 541f), which is away from the light placement portion 610, and the protruding portion 571 straightly inclines towards a direction of being away from the light placement portion 610 and the first plane 530. The protruding portion 571 includes a fourth light reflecting inclined plane 914. The fourth light reflecting inclined plane 914 is connected with the first inclined flat plate 541f at the outmost side and inclines towards a direction of being away from the light placement portion 610 and the first plane 530. Therefore, the fourth light reflecting inclined plane 914 faces towards the linear light source 700 and is used for reflecting light to a direction T1 of the upper reflection member 400 reverse to the lower reflection member 502.

In this way, when the linear light source 700 emits light, the light-guiding member 304 guides light to the fourth light reflecting inclined plane 914 in a concentrated way, and then the fourth light reflecting inclined plane 914 guides all the light to move towards the direction T1 of the upper reflection member 400 of the light-guiding element 204.

For example, an included angle θ11 formed between the fourth light reflecting inclined plane 914 and the adjacent first inclined flat plate 541f is between 150° (degrees) and 180° (degrees).

Referring to FIG. 7b, FIG. 7b illustrates a transverse cross-sectional view of another change of the laminate lamp apparatus 104 in this embodiment of the present disclosure.

FIG. 7b shows the laminate lamp apparatus 104 formed by two illumination modules 204 shown in FIG. 7a.

Specifically, the two light-guiding elements 304 are arranged in reverse directions on the bottom face 901. That is, one face (i.e., the first side face 510) of one light-guiding element 304 and one face (i.e., the second side face 410) of the other light-guiding face 304, which are away from the light outputting trough 620, face towards each other (are even bonded together in other embodiments). The two linear light sources 700 are arranged in reverse directions and are between the two light outputting troughs 620. Each fourth light reflecting inclined plane 914 is used for reflecting the light L6 from each linear light source 700 to the light diffusion plate 800.

In this way, when each light-guiding element 304 guides light L6 from the linear light source 700 to the fourth light reflecting inclined plane 914 facing towards the linear light source 700 in a concentrated way, each fourth light reflecting inclined plane 914 reflects the light L6 from each linear light source 700 to the light diffusion plate 800, and with the light diffusion effect of the light diffusion plate 800, the laminate lamp apparatus 104 provides an area light source with uniform light on one side of the light diffusion plate 800.

In addition, in an aspect of the embodiment, each protruding portion 571 is parallel and level to the upper reflection member 400, and specifically, one side 572 of each protruding portion 571, which is away from the first reflective portion 540, is parallel and level to the second plane 430 of the upper reflection member 400, so that the light diffusion plate 800 can be parallel and levelly arranged on the protruding portion 571 and the upper reflection member 400.

However, the embodiment of the present disclosure is not limited to the above, and the two light-guiding elements 304 may also be arranged with no gap therebetween.

It should be pointed out that since the light outputting trough 620 between the second reflective portion 440 and the first reflective portion 540 can effectively concentrate and guide light out of the light outputting trough 620 without providing a light guiding plate therein, the illumination modules 200-204 of the present disclosure can be referred to as illumination modules without light guiding plates.

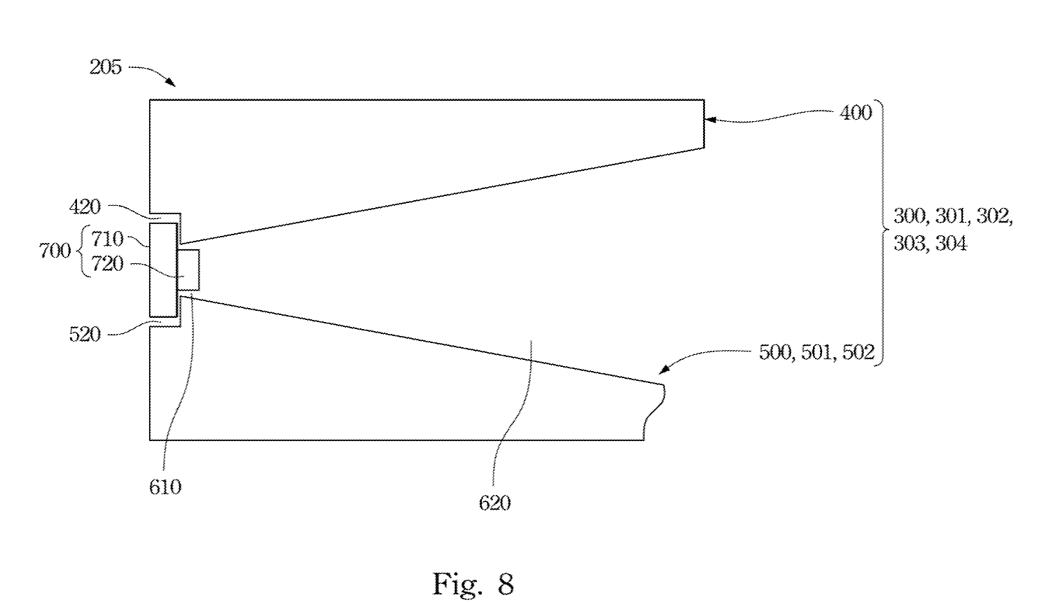

Referring to FIG. 8, FIG. 8 illustrates a partial transverse cross-sectional view of the illumination module 205 in yet another embodiment of the present disclosure.

In this embodiment, the light placement portion 610 includes a first recessed portion 520 and a second recessed portion 420. The first recessed portion 520 is arranged on the lower reflection member 500, and the second recessed portion 420 is arranged on the upper reflection member 400 and is communicated with the first recessed portion 520. Circuit boards 710 are accommodated both in the second recessed portion 420 and the first recessed portion 520, and the LEDs 720 face towards the light outputting troughs 620, so as to emit light towards the light outputting troughs 620.

In conclusion, by means of the light-guiding elements, the illumination modules without light guiding plates and the laminate lamp apparatus of the present disclosure, the first reflective portion and the second reflective portion of the light-guiding element, which face toward each other, not only can effectively regulate the light emitting angle so as to concentrate the light emitting range, but also can provide a solution which is easy in production and low in cost with the simple structure.

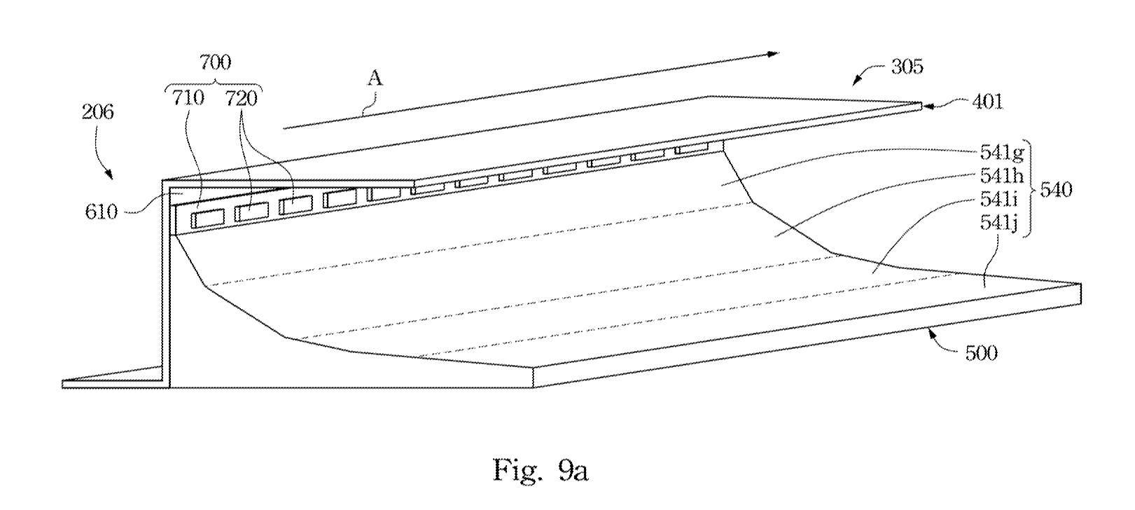

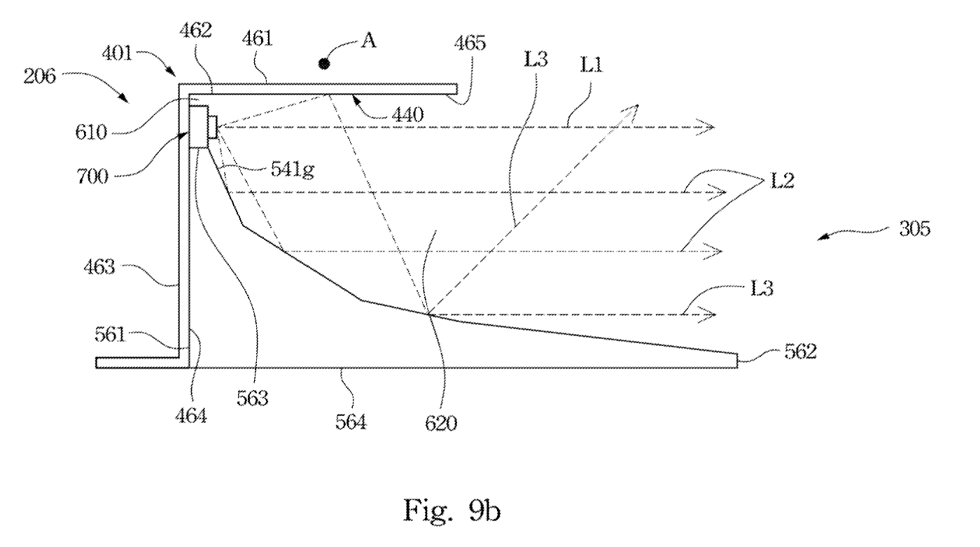

Referring to FIGS. 9a and 9b, FIG. 9a illustrates a schematic perspective view of a change of the illumination module 206 in still yet another embodiment of the present disclosure, and FIG. 9b illustrates a transverse cross-sectional view of FIG. 9a.

In this embodiment, the illumination module 206 includes a light-guiding element 305 and a linear light source 700. The light-guiding element 305 includes an upper reflection member 401 and a lower reflection member 500 which can be disassembled or assembled. The exterior structures of the upper reflection member 401 and the lower reflection member 500 are not symmetric to each other.

The lower reflection member 500 is strip-shaped, extends towards a longitudinal axis direction A, is connected with the upper reflection member 401, and includes a first reflective portion 540. The upper reflection member 400 is also strip-shaped and extends towards the longitudinal axis direction A. The upper reflection member 400 is for example a frame. The upper reflection member 400 includes a second reflective portion 440. The second reflective portion 440 is a reflecting plane 465. The first reflective portion 540 faces towards the reflecting plane 465, wherein a light placement portion 610 and a light outputting trough 620 are formed between the reflecting plane 465 and the first reflective portion 540. The light placement portion 610 is used for placing this linear light source 700, so that the linear light source 700 emits light towards the light outputting trough 620. The light outputting trough 620 is gradually expanded largely according to a direction of being away from the light placement portion 610.

Specifically, the first reflective portion 540 includes one or more first adjacent inclined flat plates with different inclined angles in sequence, (such as a first inclined flat plate 541c shown in FIG. 3; two first inclined flat plates 541a-541b shown in FIG. 2; three first inclined flat plates 541d-541f shown in FIG. 4; or four first inclined flat plate 541g-541j shown in FIGS. 9a and 9b), so as to reflect light to the light outputting trough 620.

The lower reflection member 500 further includes a first inner side face 561, a first outer side face 562, a first upper plane 563 and a first lower plane 564. The first upper plane 563 is adjacent to the first inner side face 561 and one of the first inclined flat plates 541g respectively. The first lower plane 564 is parallel to the first upper plane 563 and is adjacent to the first inner side face 561 and the first outer side face 562.

The upper reflection member 401 includes a Z-shaped structure (the cross section is Z-shaped) and at least includes an L-shaped structure (the cross section is L-shaped), and for example is formed by folding a plate, so as to form a second upper plane 461a second lower plane 462, a second outer side face 463 and a second inner side face 464. The second lower plane 462, i.e. the above mentioned reflecting plane 465, is parallel to the second upper plane 461 and faces towards the first reflective portion 540, so as to reflect light to the first reflective portion 540 (shown in FIG. 9b). The second inner side face 464 is parallel to the second outer side face 463 and is bonded with the first inner side face 561. A linear space formed among the second lower plane 462, the second inner side face 464 and the first upper plane 563 is the light placement portion 610 so as to accommodate the linear light source 700. Therefore, when being arranged on the light placement portion 610, the linear light source 700 is at least adhered to the first upper plane 563 of the lower reflection member 500 and the second inner side face 464 of the upper reflection member 401.

It should be understood that the manner of fixing the linear light source 700 on the light placement portion 610 is not limited, and for example, the linear light source 700 is fixed on the light placement portion 610 in a fasten or bolt locking manner.

In this way, when the linear light source 700 emits light out from the light outputting trough 620, the first part of light L1 is directly emitted outwards via the light outputting trough 620, and the second part of light L2 is redirected to the light outputting trough 620 directly through reflection by the first inclined flat plates 541g-541j after moving to the first inclined flat plates 541g-541j. Furthermore, the third part of light L3 is gradually redirected to the light outputting trough 620 after being repeatedly reflected by the reflecting plane 465 and the first inclined flat plates 541g-541j.

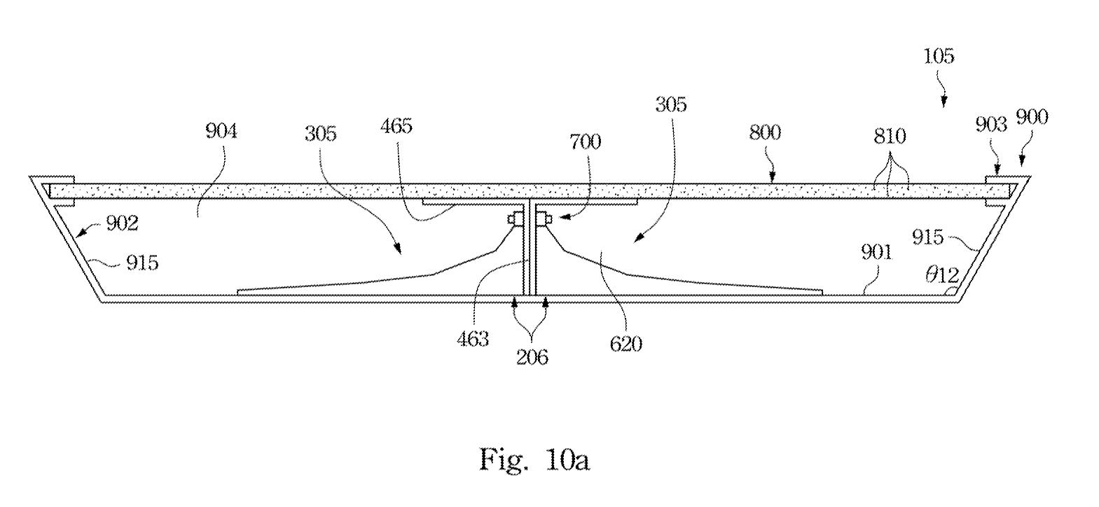

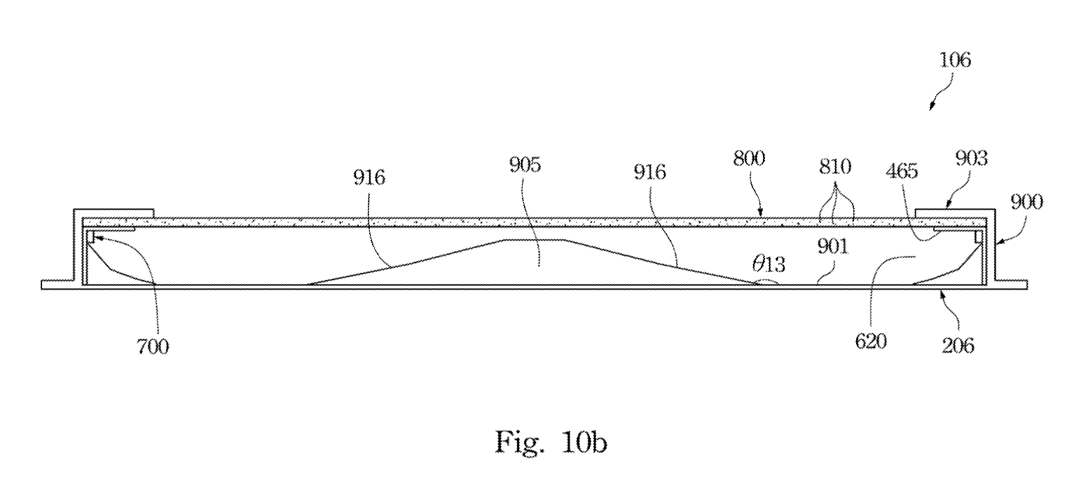

Referring to FIG. 10a, FIG. 10a illustrates a transverse cross-sectional view of a change of the laminate lamp apparatus in the embodiment of the present disclosure.

In FIG. 10a, specifically, the two light-guiding elements 305 are arranged on the bottom face 901 in reverse directions. That is, the second outer side faces 463 of the two frames face towards each other and are even bonded together. Furthermore, the two linear light sources 700 are arranged in reverse directions, both between the two light outputting troughs 620, and respectively face towards one of the inner wails 902. In addition, the inner wall 902 facing towards each linear light source 700 has a fifth light reflecting inclined plane 915, and the fifth light reflecting inclined plane 915 is used for reflecting light from each linear light source 700 to the light diffusion plate 800.

In this way, when each light-guiding element 305 guides light from the linear light source 700 to the inner wall 902 facing towards the linear light source 700 in a concentrated way, each fifth light reflecting inclined plane 915 reflects light from each linear light source 700 to the light diffusion plate 800, and with the light diffusion effect of the light diffusion plate 800, the laminate lamp apparatus 105 provides an area light source with uniform light on one side of the light diffusion plate 800.

Referring to FIG. 10b, FIG. 10b illustrates a transverse cross-sectional view of another change of the laminate lamp apparatus 106 in the embodiment of the present disclosure.

In FIG. 10b, specifically, the two light-guiding elements 305 are arranged on the bottom face 901 in reverse directions and are respectively adhered to one of the inner wails 902, so that the two light-guiding elements 305 keep a distance away from each other and cannot be connected physically. That is, the two light-guiding elements 305 face towards each other via the light outputting troughs 620, and the two light outputting troughs 620 are both between these two linear light sources 700, so that the two linear light source 700 emit light along an opposite direction.

In addition, the fixing frame 900 further includes a protruding portion 905. The protruding portion 905 is arranged on the bottom face 901, between the two linear light sources 700 and protrudes towards the direction of the light diffusion plate 800. The protruding portion 905 at least includes two adjacent sixth light reflecting inclined planes 916, and each sixth light reflecting inclined plate 916 faces towards one of the linear light sources 700.

In this way, when each light-guiding element 305 guides light from the linear light source 700 (referring to FIG. 5b) to the sixth light reflecting inclined plane 916 facing towards the linear light source 700 in a concentrated way, the sixth light reflecting inclined plane 916 reflects the light from each linear light source 700 to the light diffusion plate 800, and with the light diffusion effect of the light diffusion plate 800, the laminate lamp apparatus 105 provides an area light source with uniform light on one side of the light diffusion plate 800.

However, it should be understood that, in the present disclosure, it is not limited whether the protruding portion 905 is contacted or not contacted with the light diffusion plate 800. The protruding portion 905 helps to carry the light diffusion plate 800 when being contacted with the light diffusion plate 800. Furthermore, the protruding portion 905 is not limited to be formed below these sixth light reflecting inclined planes 912 and can be solid or hollow.

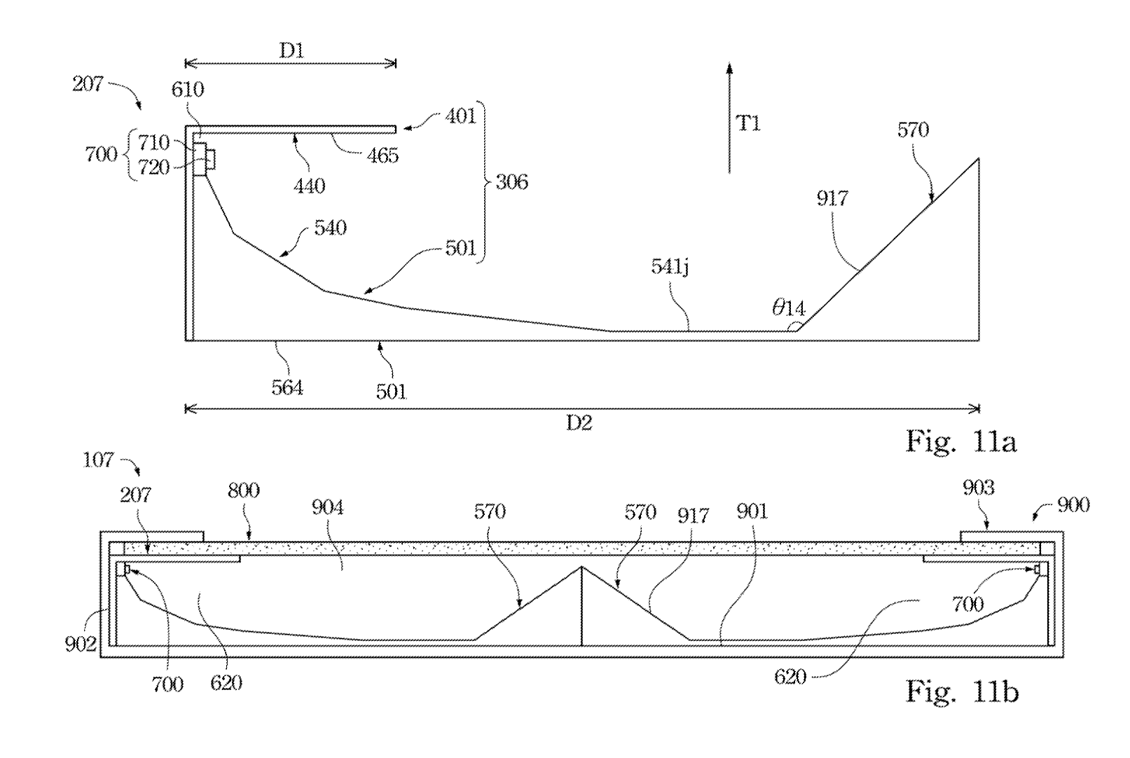

Referring to FIG. 11a, FIG. 11a illustrates a transverse cross-sectional view of another change of the illumination module in still yet another embodiment of the present disclosure.

In another change of this embodiment, the exterior structures of the first reflective portion 540 and the reflecting plane 465 of the light-guiding element 306 are not symmetric to each other.

For example, the lower reflection member 501 is protruded more than the upper reflection member 401, so that the width D2 of the lower reflection member 501 (i.e., the first lower plane 564) is greater than the width D1 of the reflecting plane 465 of the upper reflection member 401.

In addition, the lower reflection member 501 includes a protruding portion 570. The protruding portion 570 is arranged on one side of the first reflective portion 540 (such as the first inclined flat plate 541j), which is away from the light placement portion 610, and protrudes towards a direction of the lower reflection member 500, which is opposite to (or away from) the first lower plane 564, so as to reflect light to a direction T1 of the upper reflection member 400, which is opposite to the lower reflection member 501. The protruding portion 570 for example includes a seventh light reflecting inclined plane 917. The seventh light reflecting inclined plane 917 is connected with the first inclined flat plate 541j at the outermost side and inclines towards a direction of being way from the light placement portion 610 and the first lower plane 564.

In this way, when the linear light source 700 emits light, after the light-guiding element 306 guides the light to the seventh light reflecting inclined plane 917, the seventh light reflecting inclined plane 917 guides all the light to move towards a direction (such as direction T1) of the lower reflection member 501, which is opposite to (or away from) the first lower plane 564.

In addition, one face of the protruding portion 570, which is away from the linear light source 700, is vertical to the first lower plane 564. The protruding portion 570 is bonded with other components so as to stabilize the placement of the illumination module 207.

For example, an included angle 814 formed between the seventh light reflecting inclined plane 917 and the adjacent first inclined flat plate 541j is between 150° (degrees) and 180° (degrees).

Referring to FIG. 11b, FIG. 11b illustrates a transverse cross-sectional view of still yet another change of the laminate lamp apparatus 107 in the embodiment of the present disclosure.

FIG. 11b shows the laminate lamp apparatus 107 formed by two illumination modules 207 shown in FIG. 11a.

Specifically, the two light-guiding elements 306 are connected with each other by the protruding portions 570, so that one side of one protruding portion 570 and one side of the other protruding portion 570, which are away from the linear light sources 700, are bonded with each other. Frames of the two light-guiding elements 306 keep a distance away from each other and cannot be connected physically. Furthermore, the two protruding portions 570 and the light outputting troughs 620 are all between the two linear light sources 700, and each linear light source 700 can output light to the corresponding seventh light reflecting inclined plane 917 respectively via the light outputting troughs 620.

In this way, when each light-guiding element 306 guides the light from the linear light source 700 to the seventh light reflecting inclined plane 917, each seventh light reflecting inclined plane 917 reflects the light of each linear light source 700 to the light diffusion plate 800, and with the light diffusion effect of the light diffusion plate 800, the laminate lamp apparatus 107 provides an area light source with uniform light on one side of the light diffusion plate 800.

However, the embodiment of the present disclosure is not limited to the above, and the protruding portions of the two light-guiding elements 306 keep a gap therebetween.

In addition, in other changes of the above embodiments, it can be seen from FIG. 11b that the above two protruding portions may also be regarded as a single triangular protruding portion, so that the two lower reflection members (reference number is 501) are integrated as a single component, and this triangular protruding portion has two seventh light reflecting inclined planes (reference number is 917). The two seventh light reflecting inclined planes (reference number is 917) are adjacent to each other, so as to form an included angle upheaving towards the light diffusion plate (reference number is 800).

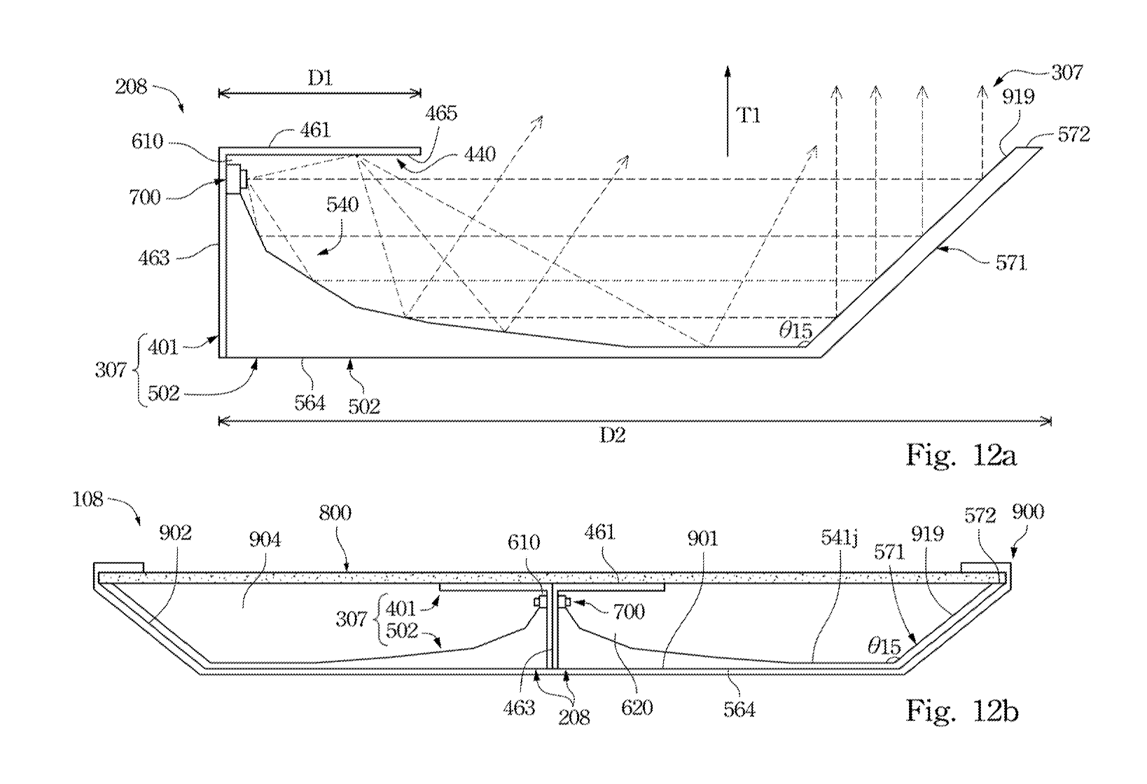

Referring to FIG. 12a, FIG. 12a illustrates a transverse cross-sectional view of yet another change of the illumination module 208 in still yet another embodiment of the present disclosure.

In yet another change of this embodiment, the reflecting plane 465 of the light-guiding element 307 and the first reflective portion 540 are asymmetric to each other in appearance.

For example, the lower reflection member 502 is protruded more than the upper reflection member 401, so that the width D2 of the lower reflection member 502 (i.e., the first lower plane 564) is greater than the width D1 of the reflecting plane 465.

In addition, the first reflective portion 540 is protruded more than the reflecting plane 465, and the lower reflection member 502 includes a protruding portion 571. The protruding portion 571 is platy-shaped, arranged on one side of the first reflective portion 540 (such as the first inclined flat plate 541j), which is away from the light placement portion 610, and straightly inclines towards a direction of being away from the light placement portion 610 and the first lower plane 564, so as to reflect light to the direction of the upper reflection member 401 reverse to the lower reflection member 502. The protruding portion 571 for example includes a ninth light reflecting inclined plane 919. The ninth light reflecting inclined plane 919 is connected with the first inclined flat plate 541j at the outermost side and inclines towards a direction of being away from the light placement portion 610 and the first lower plane 564, therefore, the ninth light reflecting inclined plane 919 faces towards the light outputting trough 620 or the upper reflection member 400.

In this way, when the linear light source 700 emits light, the light-guiding element 307 guides light to the ninth light reflecting inclined plane 919, and next, the ninth light reflecting inclined plane 919 guides all the light to move towards the direction such as direction T1) of the lower reflection member 502, which is opposite to (or away from) the first lower plane 564.

For example, an included angle θ15 formed between the ninth light reflecting inclined plane 919 and the adjacent first inclined flat plate 541j is between 150° (degrees) and 180° (degrees).

Referring to FIG. 12b, FIG. 12b illustrates a transverse cross-sectional view of still yet another change of the laminate lamp apparatus 108 in still yet another embodiment of the present disclosure.

FIG. 12b shows the laminate lamp apparatus 108 formed by two illumination modules 208 shown in FIG. 12a.

Specifically, the two illumination modules 208 are arranged on the bottom face 901 in reverse directions. That is, the second outer side faces 463 of the two frames face towards each other and are even bonded together. The two linear light sources 700 are arranged in reverse directions and are both between the two light outputting troughs 620 or the two protruding portions 571. Each linear light source 700 can emit light to the ninth light reflecting inclined plane 919 of the protruding portion 571 facing towards the linear light source 700 via the light outputting trough 620 towards reverse directions.

In this way, when each light-guiding element 307 guides light from the linear light source 700 to the ninth light reflecting inclined plane 919 facing towards the linear light source 700, each ninth light reflecting inclined plane 919 reflects the light from each linear light source 700 to the light diffusion plate 800, and with the light diffusion effect of the light diffusion plate 800, the laminate lamp apparatus 108 provides an area light source with uniform light on one side of the light diffusion plate 800.

In addition, in an aspect of this embodiment, each protruding portion 571 is parallel and level to one face of the upper reflection member 401. Specifically, one face of each protruding portion 571, which is away from the first reflective portion 540, is parallel and level to the second upper plane 461 of the upper reflection member 401, so that the light diffusion plate 800 is parallel and levelly arranged on the protruding portion 571 and the upper reflection member 401.

However, the embodiments of the present disclosure are not limited to the above, and the two light-guiding elements 307 may also keep no gap therebetween.

It should be understood that, since a light guiding plate does not need to be arranged in the light outputting trough between the reflecting plane and the first reflective portion, the illumination module of the present disclosure can be referred to as a illumination module without light guiding plates.

Although the present disclosure has been disclosed with reference to the above embodiments, these embodiments are not intended to limit the present disclosure. It will be apparent to those skilled in the art that various modifications and variations can be made without departing from the scope or spirit of the present disclosure. Therefore, the scope of the present disclosure shall be defined by the appended claims.

What is claimed is:

1. A light-guiding element, comprising:
a lower reflection member extending along a longitudinal axis direction and comprising a first reflective portion, wherein the first reflective portion comprises at least one first inclined flat plate; and
an upper reflection member extending along the longitudinal axis direction, connected to the lower reflection member and comprising a second reflective portion, wherein the second reflective portion faces towards the first reflective portion,
wherein a light placement portion and a light outputting trough are formed between the first reflective portion and the second reflective portion, and the light outputting trough is gradually expanded largely along a direction of being away from the light placement portion.

2. The light-guiding element of claim 1, wherein the second reflective portion comprises:
at least one second inclined flat plate facing towards the at least one first inclined flat plate.

3. The light-guiding element of claim 2, wherein the lower reflection member further comprises a first side face and a first plane, and the first side face is adjacent to the first plane and the at least one first inclined flat plate; the upper reflection member further comprises a second side face and a second plane, and the second side face is adjacent to the second plane and the at least one second inclined flat plate; and the first plane is parallel to the second plane.

4. The light-guiding element of claim 3, wherein the first reflective portion and the second reflective portion are symmetric to each other in appearance.

5. The light-guiding element of claim 4, wherein, when the first reflective portion comprises a single one of the at least first inclined flat plate, an included angle formed between a virtual datum plane vertical to the first plane and the first inclined flat plate is an acute angle.

6. The light-guiding element of claim 4, wherein the at least one first inclined flat plate comprises multiple first inclined flat plates, the first inclined flat plates have difference inclined angles, and the respective first inclined are less inclining with respective distances away from the light placement portion.

7. The light-guiding element of claim 6, wherein each included angle formed between multiple virtual datum planes vertical to the first plane and the first inclined flat plates is an acute angel increasing gradually towards a direction of being away from the light placement portion.

8. The light-guiding element of claim 2, further comprising:
a first light reflecting layer adhered to the at least one first inclined flat plate; and
a second light reflecting layer adhered to the at least one second inclined flat plate.

9. The light-guiding element of claim 3, wherein the first reflective portion and the second reflective portion are asymmetric to each other in appearance.

10. The light-guiding element of claim 9, wherein the width of the first reflective portion is greater than that of the second reflective portion, and the lower reflection member further comprises a protruding portion, wherein the protruding portion is arranged on one side of the first reflective portion, which is away from the light placement portion, and protrudes towards the direction of the lower reflection member, which is away from the first plane, so as to reflect light to the direction of the lower reflection member, which is away from the first plane.

11. The light-guiding element of claim 10, wherein the protruding portion comprises:
a first light reflecting inclined plane connected with the first inclined flat plate and facing towards the light outputting trough, wherein an included angle formed between the first light reflecting inclined plane and the first inclined flat plate is in a range from 150° to 180°.

12. The light-guiding element of claim 10, further comprising another upper reflection member which is arranged opposite to the upper reflection member, keeps a distance away from the upper reflection member, and the another upper reflection member comprises another second reflective portion;
the lower reflection member further comprises another first reflective portion which is arranged opposite to the first reflective portion and the another second reflective portion and faces towards the another second reflective portion, wherein another light placement portion and another light outputting trough are formed between the another second reflective portion and the another first reflective portion, and the another light outputting trough is gradually expanded largely according to a direction of being away from the light placement portion; and
the protruding portion is arranged between the first reflective portion and the another first reflective portion and comprises two first light reflecting inclined planes, wherein the first light reflecting inclined planes are adjacent to each other and have an included angle upheaving towards the gap.

13. The light-guiding element of claim 10, wherein the protruding portion is plate-shaped and straightly inclines towards a direction of being away from the light placement portion and the first plane, and the protruding portion is parallel and level to the second plane.

14. The light-guiding element of claim 1, wherein the second reflective portion and the first reflective portion are asymmetric to each other in appearance.

15. The light-guiding element of claim 14, wherein the lower reflection member further comprises a first upper plane, a first lower plane and a first inner side face; the first inner side face is adjacent to the first upper plane and the first lower plane and is connected with the upper reflection member; the first upper plane is adjacent to the at least one first inclined flat plate; and the upper reflection member is a frame which comprises an L-shaped structure, and the second reflective portion is a reflecting plane which is parallel to the first lower plane.

16. The light-guiding element of claim 15, wherein the lower reflection member further comprises:
a protruding portion arranged on one side of the first reflective portion, which is away from the light placement portion, and protrudes towards the direction of the lower reflection member, which is away from the first lower plane, so as to reflect light to the direction of the lower reflection member, which is away from the first lower plane.

17. The light-guiding element of claim 16, wherein the protruding portion comprises:
a first light reflecting inclined plane connected with the first inclined flat plate and facing towards the light outputting trough, wherein an included angle formed by the first light reflecting inclined plane and the first inclined flat plate is in a range from 150 to 180°.

18. The light-guiding element of claim 16, wherein the protruding portion is plate-shaped and straightly inclines towards a direction of being away from the light placement portion and the first lower plane, wherein the protruding portion is parallel and level to one side of the upper reflection member.

19. The light-guiding element of claim 16, further comprising another upper reflection member which is arranged opposite to the upper reflection member and keeps a distance away from the upper reflection member, and the another upper reflection member comprises another second reflective portion;
the lower reflection member further comprises another first reflective portion which is arranged opposite to the first reflective portion and the another second reflective portion and faces towards the another second reflective portion, wherein another light placement portion and another light outputting trough are formed between the another second reflective portion and the another first reflective portion, and the another light outputting trough is gradually expanded largely according to a direction of being away from the light placement portion; and
the protruding portion comprises two first light reflecting inclined planes, and the first light reflecting inclined planes are adjacent to each other and have an included angle upheaving towards the gap.

20. An illumination module, comprising:
the light-guiding element of claim 1; and
a linear light source extending along the longitudinal axis direction, arranged in the light placement portion and emitting light towards the light outputting trough, wherein the linear light source comprises:
a circuit board; and
multiple light-emitting diodes arranged on the circuit board linearly.

21. A laminate lamp apparatus, comprising:
two illumination modules, each of which comprises:
a light-guiding element, comprising:
a lower reflection member extending along a longitudinal axis direction and comprising a first reflective portion, wherein the first reflective portion comprises at least one first inclined flat plate; and
an upper reflection member extending along the longitudinal axis direction, connected with the lower reflection member and comprising a second reflective portion facing towards the first reflective portion, wherein a light placement portion and a light outputting trough are formed between the first reflective portion and the second reflective portion, and the light outputting trough is gradually expanded largely according to a direction of being away from the light placement portion; and
two linear light sources extending along the longitudinal axis direction, individually arranged in one of the light placement portions and emitting light towards the corresponding light outputting trough; and
a light diffusion plate arranged on one side of each of the two upper reflection members opposite to the second reflective portion.

22. The laminate lamp apparatus of claim 21, further comprising a fixing frame which comprises:
a bottom face;
multiple inner walls defining a accommodation groove with the bottom face, wherein the accommodation groove is used for accommodating the illumination modules; and
at least one clamping portion arranged on one side of the fixing frame, opposite to the bottom face, and used for fixing the light diffusion plate on the upper reflection members.

23. The laminate lamp apparatus of claim 22, wherein the first reflective portion and the second reflective portion of the light-guiding element in each of the illumination modules are symmetric to each other in appearance.

24. The laminate lamp apparatus of claim 22, wherein the first reflective portion and the second reflective portion of the light-guiding element in each of illumination modules are asymmetric to each other in appearance.

25. The laminate lamp apparatus of claim 23, wherein the two light-guiding elements are arranged in the accommodation groove in reserve directions, and the two linear light sources are arranged between the two light outputting troughs and respectively face towards one of the inner walls.

26. The laminate lamp apparatus of claim 25, wherein each of the inner walls facing towards the liner light source has a second light reflecting inclined plane, and the second light reflecting inclined plane is used for reflecting light to the light diffusion plate.

27. The laminate lamp apparatus of claim 23, wherein the two light-guiding elements are arranged opposite to each other, respectively adhered to one of the inner walls and keep a distance from each other, and the two light outputting troughs are arranged between the two linear light sources.

28. The laminate lamp apparatus of claim 27, wherein the fixing frame comprises:
a protruding portion which is arranged on the bottom face, protruded towards the direction of the light diffusion plate, arranged between the two linear light sources and comprises two third light reflecting inclined planes, wherein each of the third light reflecting inclined planes faces towards one of the two linear light sources so as to reflect light to the light diffusion plate.

29. The laminate lamp apparatus of claim 24, wherein the light-guiding element in each of the illumination modules further comprises:
a protruding portion positioned on one side of the first reflective portion, which is away from the light placement portion, wherein the protruding portion protrudes towards the direction of the light diffusion plate and comprises a first light reflecting inclined plane, and the first light reflecting inclined plane is used for reflecting light to the light diffusion plate.

30. The laminate lamp apparatus of claim 29, wherein the light-guiding elements in the two illumination modules are arranged in reverse directions, and the two linear light sources are arranged between these two protruding portions and respectively face towards the first light reflecting inclined planes of the protruding portions.

31. The laminate lamp apparatus of claim 29, wherein the two light-guiding elements are facing towards each other, the two protruding portions are arranged between the two linear light sources, and the first light reflecting inclined planes of the protruding portions respectively face towards one of the two linear light sources.

32. The laminate lamp apparatus of claim 23, wherein the second reflective portion comprises at least one second inclined flat plate.

33. The laminate lamp apparatus of claim 24, wherein the second reflective portion comprises a reflecting plane.
